(19) United States
(12) Patent Application Publication
(10) Pub. No.: US 2026/0027766 A1
(43) Pub. Date: Jan. 29, 2026

(54) DEVICE FOR SEPARATING A MODEL MOLD FROM A THERMOFORMED PLASTIC PART

(71) Applicant: Dental Manufacturing Unit GmbH, Puch bei Hallein (AT)

(72) Inventors: Martin Huber, Pfarrwerfen (AT); Alfons Wörmer, Bischofshofen (AT)

(21) Appl. No.: 19/270,160

(22) Filed: Jul. 15, 2025

(30) Foreign Application Priority Data
Jul. 25, 2024 (AT) A50624/2024

(51) Int. Cl. B29C 51/44; A61C 13/20

(52) U.S. Cl. CPC B29C 51/44; A61C 13/20

(57) ABSTRACT

A device for separating a model mold (7), in particular a dental model mold, from a thermoformed plastic part, for example a plastic film (4), has a separating platform (1) that has a removal opening (2), the edge of which forms a stop limit (3) for a free edge of the plastic part, and a puller (6) for the model mold (7). The puller (6) is arranged on the side of the separating platform (1) facing away from the stop limit (3) and can be moved from an engagement position to a removal position along a pulling-off direction (5), and the puller (6) is mounted on a rotation axis extending parallel to a plane spanned by the removal opening (2) and is attached to a lever (10) movable about the rotation axis. The puller (6) comprises an engagement hook (8) for the model mold (7) and, on the one hand, the lever (10) is articulated to the separating platform (1) via two sliding joints (12, 13) arranged at a distance from one another in the longitudinal direction of the lever (12, 13), wherein one of the sliding joints (12) forms the axis of rotation for the lever (10), and/or, on the other hand, the puller (6) is articulated to the lever (10) via an articulation axis (11) extending parallel to the axis of rotation.

The invention relates to a device for separating a model mold, in particular a dental model mold, from a thermoformed plastic part, in particular a plastic film. The device comprises a separating platform which has a removal opening, the edge of which forms a stop limit for a free edge of the plastic part, and a puller for the model mold, which is arranged on the side of the separating platform facing away from the stop limit, can be displaced from an engagement position into a removal position along a pulling-off direction, is mounted on an axis of rotation extending parallel to a plane spanned by the removal opening and is attached to a lever which can be moved about the axis of rotation.

In the prior art, devices for separating a dental model mold from a thermoformed plastic part, namely a thermoforming sheet, are known, for example from AT524224B1. The device comprises a separating platform which has a removal opening. A puller is also arranged on the side of the separating platform facing away from the stop limit, which puller can be displaced from an engagement position into a removal position and has a stop formed by a pulling means, in particular a strip, arranged on the thermoforming model for engagement. The puller is mounted on an axis of rotation running parallel to a plane spanned by the removal opening. During demolding, the model mold with the thermoforming sheet is positioned over the removal opening, the edge of which forms a stop limit for the free thermoforming edge of the thermoforming sheet. The movable puller is then brought into the engagement position, in which the puller engages with the stop of the pulling means. Finally, the puller is moved beyond the engagement position into the removal position, in which the thermoforming pattern is removed from the thermoforming sheet through the removal opening

It has been shown that due to different model mold contours and undercuts, which are caused, for example, by various tooth misalignments of the underlying denture, different demolding forces are involved in each case, which must be taken into account accordingly during the demolding process, i.e. when moving the puller from the engagement position to the removal position. In this context, the previously known devices can have the disadvantage that an undesirable material distortion occurs during demolding, particularly in the case of plastic films that are difficult to demold due to complex contours and undercuts, which ultimately leads to the thermoformed part concerned having to be removed as scrap. In addition, the previously known device is somewhat disadvantageous to handle, not least when changing to other model molds, as the tensioning means, which is knotted tightly, for example, has to be reattached to the model mold or removed from the old model mold each time.

There is therefore a need for a device of the type described above, which enables more reproducible demolding results with reduced waste and improved handling despite different model mold contours.

The invention solves the task set by the fact that the puller comprises an engagement hook for the model mold and that, on the one hand, the lever is articulated to the separating platform via two sliding joints arranged at a distance from one another in the longitudinal direction of the lever, wherein one of the sliding joints forms the axis of rotation for the lever and/or that, on the other hand, the puller is articulated to the lever via an articulation axis running parallel to the axis of rotation.

The lever kinematics resulting from these features, in combination with the movable mounting of the lever on the separating platform and/or the engagement hook on the lever, enables both easy insertion of the engagement hook into the model mold in the engagement position and reliable displacement of the engagement hook along the pulling-off direction into the removal position without the engagement hook being released from its engagement with the model mold in the meantime. Preferably, a hook engagement area is provided on the underside of the pattern mold, which can be designed, for example, as an engagement pocket, a bridge that can be gripped from behind or similar. Handling conditions are particularly favorable if both the lever is articulated to the separating platform via two sliding joints arranged at a distance from each other in the longitudinal direction of the lever and the engaging hook of the puller is articulated to the lever via an articulation axis running parallel to the axis of rotation. Due to the measures according to the invention and the associated possibility of deflection of the engagement hook transverse to the pulling-off direction, a particularly advantageous force transmission from the engagement hook into the model mold results during the demolding process compared to a purely monoaxial pull-off movement, as is the case with known puller belts. Due to the bearing-related lever ratios, manual movement corrections by hand are also easily possible with little effort. In principle, however, it is also conceivable that the lever could be drive-connected to a suitable actuator.

To further improve handling, it is proposed that the lever is supported on the release platform via a reset element that runs along a reset direction inclined to the pulling-off direction. As a result, after the plastic part has been removed from the mold, the model mold, which is initially still in the removal position, is moved back into the engagement position by the reset element. Particularly in the event that the puller is not articulated to the lever, it is generally possible that the puller or engagement hook is also drive-connected to a reset element in such a way that the engagement hook can be displaced transversely to the pulling-off direction for the purpose of a compensating movement.

For particularly favorable demolding conditions, it is recommended that at least one of the two sliding joints, preferably the sliding joint opposite the axis of rotation, comprises a curved sliding track. The resulting link guide allows the lever to be displaced both essentially transversely and essentially parallel to the pulling-off direction.

Advantageous design conditions with reliable demolding also result if the sliding joint forming the axis of rotation comprises a long slot provided on the lever and/or that the sliding joint opposite the axis of rotation comprises a guide element provided on the lever, in particular a guide pin, for engagement in a sliding track of that sliding joint.

A compact and wear-resistant design can be achieved if the separating platform comprises a receptacle extending in the pulling-off direction, preferably a straight guide, in which a model mold support is received and can be displaced along the pulling-off direction between the engagement position and the removal position. In this context, it is preferably provided that the model mold support, which is guided in a form-fitting manner in the holder of the separating platform, has a sleeve-shaped base body, which is preferably supported on a reset element running parallel to the pulling-off direction. For particularly simple and reliable displacement, it can also be provided that the base body is supported on a pair of reset elements that extend parallel to the pulling-off direction.

In order both to further improve the insertion of the engagement hook in the engagement position and to further reduce the risk of the engagement hook slipping off the model mold during the demolding process, it is proposed that the engagement hook of the puller comprises a hook base from which a hook end section projects which extends essentially normal thereto and which has a contact surface at its free end for a hook engagement area provided on the underside of the model mold. The contact surface is such that the engagement hook can be inserted into the hook engagement area with as little force as possible, whereby it must be ensured that a reliable hold between the engagement hook and the model mold is provided in conjunction with the movable bearing of the lever or hook when moving the puller between the engagement position and the removal position.

Particularly favorable conditions with regard to both the insertion and the reliable hold of the engagement hook on the model mold arise in this context if the hook end section has a curved contour which, starting from the hook base, rises to an apex which, in relation to the length of the hook end section, lies in the half of the length facing the free end. Improved penetration can in principle also result from the fact that the opposing lateral sides of the hook end section taper from the hook base towards the free end of the hook end section.

The invention also relates to a method for separating a model mold, in particular a dental model mold, from a thermoformed plastic part, in particular using a device according to the invention. The model mold with the plastic part is positioned over the removal opening, the edge of which forms a stop limit for the free edge of the plastic part, and then the displaceable puller is brought into an engagement position in which the puller engages via its engagement hook in a hook engagement area provided on the underside of the model mold. The puller is subsequently displaced beyond the engagement position into a removal position in which the model mold is removed from the plastic part through the removal opening in the pulling-off direction.

The drawing shows an example of the object of the invention. It shows

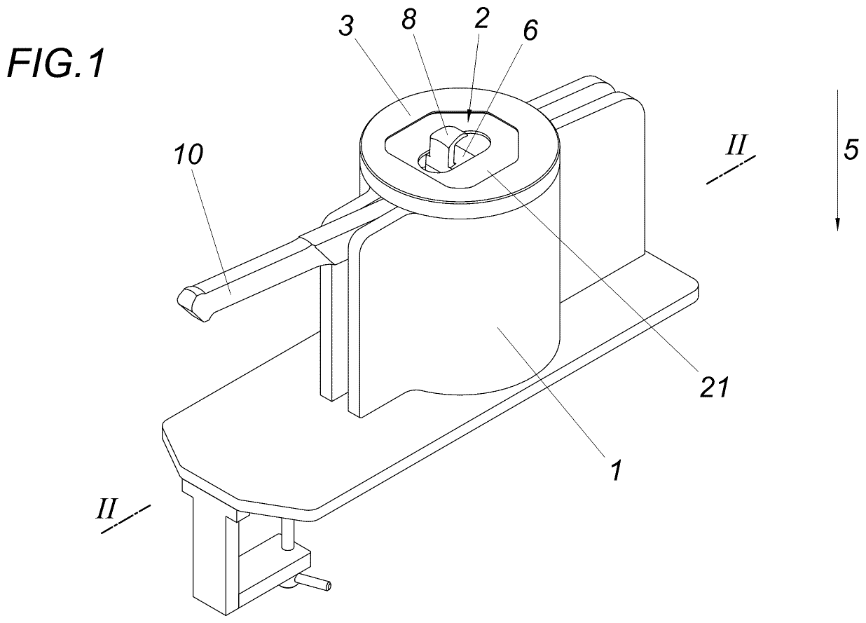

FIG. 1 a schematic oblique view of a device according to the invention in a first embodiment,

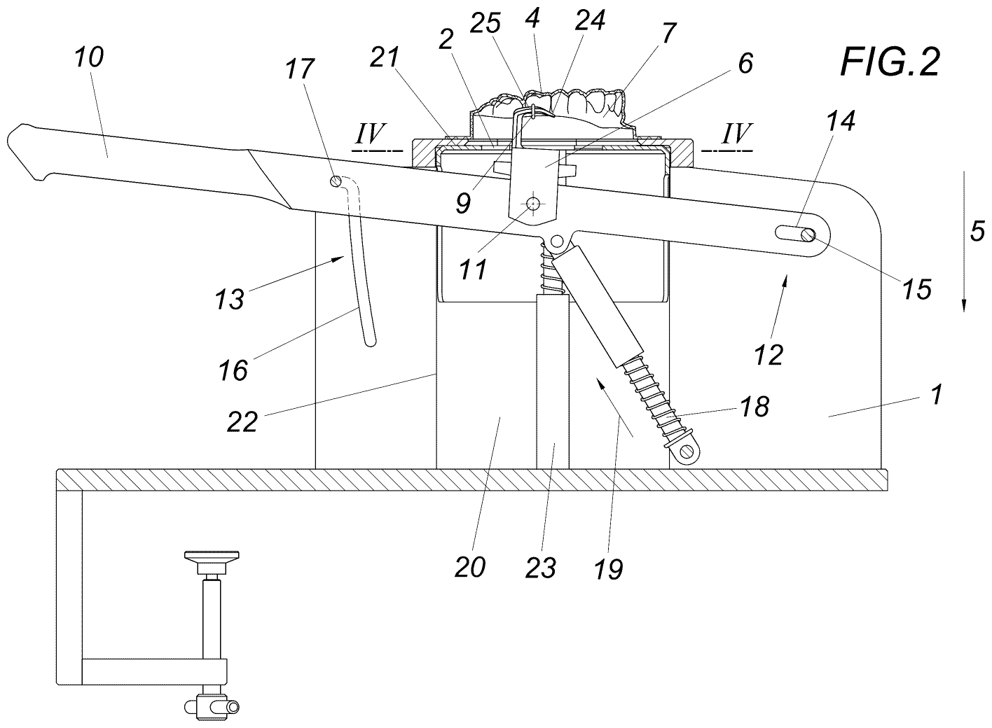

FIG. 2 a sectional view along line II-II with the device in an engagement position,

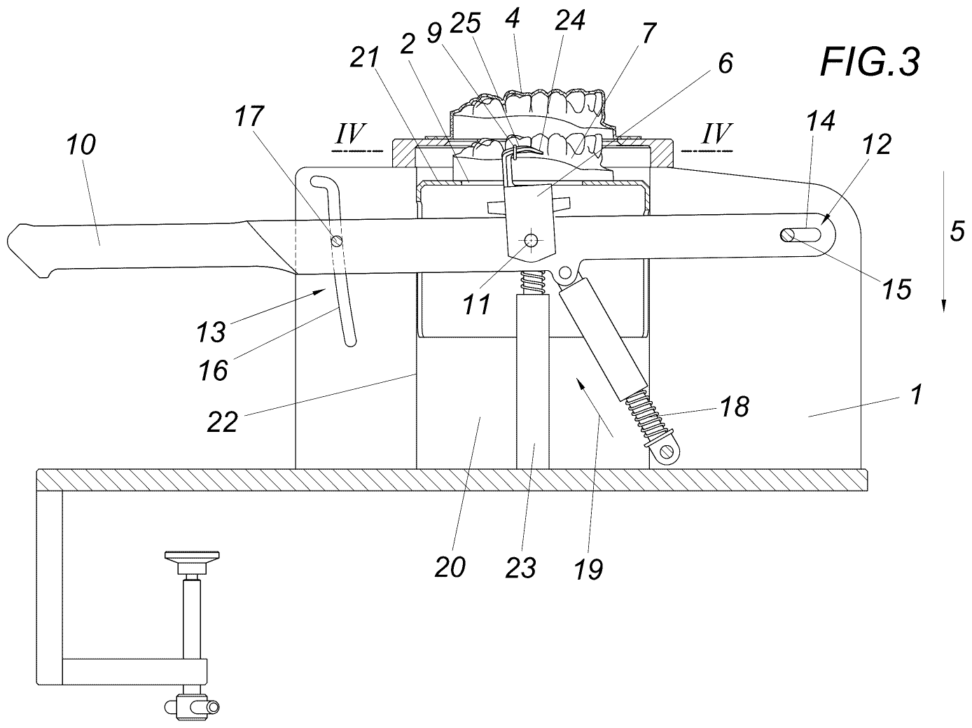

FIG. 3 a representation corresponding to FIG. 2 with the device in a removal position, and

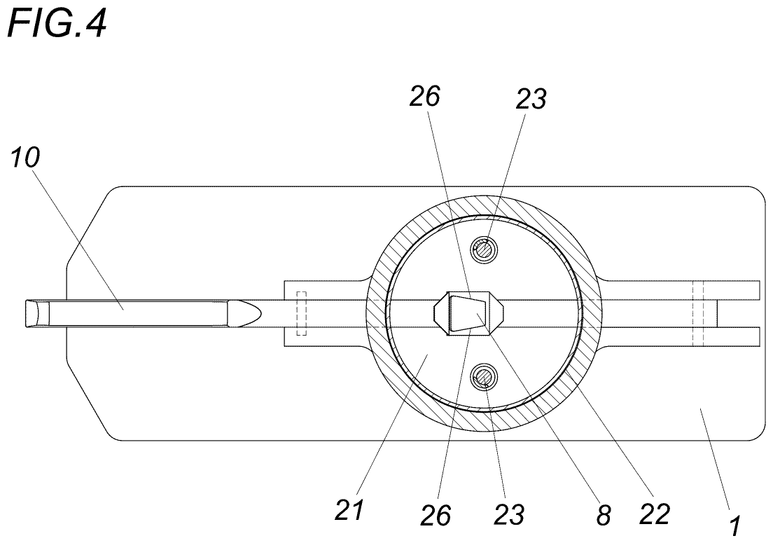

FIG. 4 a section along line IV-IV.

A device according to the invention comprises a separating platform 1 which has a removal opening 2, the edge of which forms a stop limit 3 for a free edge of a plastic part, for example a thermoformable plastic film 4. A puller 6 for a model mold 7 serving as a thermoforming mold for the plastic film 4 is arranged on the side of the separating platform 1 facing away from the stop limit 3 and can be displaced from an engagement position into a removal position along a pulling-off direction 5. The puller 6 also has an engagement hook 8 for a model mold 7.

The puller 6 can be moved between an engagement position (FIG. 2), in which the engagement hook 8 engages in a hook engagement area 9 on the underside of the model mold, and a removal position (FIG. 3), in which the plastic film 4 has been removed from the model mold 7. For this purpose, as shown in the sectional views according to FIG. 2 and FIG. 3, the puller 6 is mounted on an axis of rotation running parallel to a plane spanned by the removal opening 2 and is attached to a lever 10 that can be moved about the axis of rotation. The puller 6 is also articulated to the lever 10 via an articulation axis 11 running parallel to the axis of rotation. The lever 10, on the other hand, is articulated to the separating platform 1 via two sliding joints 12, 13 arranged at a distance from each other in the longitudinal direction of the lever. The sliding joint 12 forms the axis of rotation for the lever 10.

The sliding joint 12 comprises a long slot 14 in which a guide pin 15 arranged on the separating platform 1 engages. In order to enable a displacement of the lever 10 in the area of the opposite sliding joint 13 in a structurally favorable manner, essentially transversely as well as essentially parallel to the pulling-off direction 5, the sliding joint 13 has a curved sliding track 16. In the sliding joint 13 area, the lever 10 itself comprises a guide pin 17, which in turn engages in the curved sliding track 16 of the sliding joint 13 arranged on the separating platform 1.

To improve handling, the lever 10 is supported on the separating platform 1 via a reset element 18, which extends along a reset direction 19 inclined to the pulling-off direction 5.

The separating platform 1 also comprises a receptacle 20 extending in the pulling-off direction 5 and forming a straight guide, in which a model mold support 21 is accommodated and can be displaced along the pulling-off direction 5 between the engagement position and the removal position. The model mold support 21 guided in a form-fitting manner in the receptacle 20 has a sleeve-shaped base body 22, which is supported on a pair of reset elements 23 extending parallel to the pulling-off direction 5.

In order to provide favorable conditions with respect to both the insertion and the reliable retention of the engagement hook 8 on the model mold 7, the engagement hook 8 comprises a hook base from which a hook end portion extending substantially normal thereto projects, which hook end portion has a contact surface 24 at its free end for the hook engagement area 9 provided on the model mold underside. The hook end section has a curved contour which, starting from the hook base, rises to an apex 25 which, in relation to the length of the hook end section, lies in the half of the length facing the free end. As also shown in the plan view according to FIG. 4, the opposing lateral sides 26 of the hook end section taper from the hook base towards the free end of the hook end section.

1. A device for separating a model mold from a thermoformed plastic part, said device comprising:
a separating platform that has a removal opening the having an edge that forms a stop limit configured to engage a free edge of the plastic part c and
a puller configured to pull the model mold, wherein the puller is arranged on a side of the separating platform facing away from the stop limit and supported for movement from an engagement position to a removal position along a pulling-off direction; and
wherein the puller is mounted on a rotation axis extending parallel to a plane spanned by the removal opening and is attached to a lever movable about the rotation axis;
wherein the puller comprises an engagement hook configured to operatively engage the model mold; and
wherein, on wherein one hand, the lever is articulated to the separating platform via two sliding joints arranged at a distance from one another in the longitudinal direction of the lever, wherein one of the sliding joints forms the axis of rotation for the lever, and/or
wherein, on the other hand, the puller is articulated to the lever via an articulation axis extending parallel to the axis of rotation.

2. The device according to claim 1, wherein the lever is supported on the separating platform by a reset element that extends along a reset direction inclined relative to the pulling-off direction.

3. The device according to claim 1, wherein at least one of the two sliding joints comprises a curved sliding track.

4. The device according to claim 1, wherein the lever has a slot as part of the sliding joint forming the axis of rotation and/or that the sliding joint opposite the axis of rotation comprises a guide element, provided on the lever engaging in a sliding track of said sliding joint.

5. The device according to claim 1, wherein the separating platform comprises a receptacle extending in the pulling-off direction, said receptacle receiving a model mold support, said model mold support in said receptacle being supported for displacement between the engagement position and the removal position along the pulling-off direction.

6. The device according to claim 5, wherein the model mold support is guided in a form-fitting manner in the receptacle of the separating platform, which has a sleeve-shaped base body.

7. The device according to claim 1, wherein the engagement hook of the puller comprises a hook base from which a hook end section extends substantially normally thereto, and said hook end section has at its a free end thereof a contact surface configured to engage a hook engagement area on an underside of the model mold.

8. The device according to claim 7, wherein the hook end section has a curved contour that rises from the hook base to an apex that, relative to a length of the hook end section, lies in a half of the length of the hook facing the free end.

9. The device according to claim 7, wherein the lateral sides of the hook end section facing each other taper from the hook base toward the free end of the hook end section.

10. A method for separating a model mold, in particular a dental model mold, from a thermoformed plastic part, for example a plastic film said method comprising:
positioning the model mold with the plastic part thereof over a removal opening having an edge of which that forms a stop limit for the engageable with a free edge of the plastic part, and
then bringing a movable puller into an engagement position in which the puller engages via an engagement hook thereof in a hook engagement area provided on an underside of the model mold in an engagement position; and
displacing the movable puller beyond the engagement position into a removal position; and
pulling the model mold out of the plastic part through the removal opening in a pulling-off direction.

11. The device according to claim 1, wherein the model mold is a dental model mold and the thermoformed plastic part is a plastic film.

12. The device according to claim 4, wherein the guide element is a guide pin provided on the lever.

13. The device according to claim 5, wherein the receptacle is a straight guide.

14. The device according to claim 6, wherein the sleeve-shaped base body is supported on a reset element extending parallel to the pulling-off direction.

15. The device according to claim 2, wherein at least one of the two sliding joints comprises a curved sliding track.

16. The device according to claim 2, wherein the lever has a slot as part of the sliding joint forming the axis of rotation and/or that the sliding joint opposite the axis of rotation comprises a guide element provided on the lever in a sliding track of said sliding joint.

17. The device according to claim 3, wherein the lever has a slot as part of the sliding joint forming the axis of rotation and/or that the sliding joint opposite the axis of rotation comprises a guide element provided on the lever in a sliding track of said sliding joint.

18. The device according to claim 4, wherein the separating platform comprises a receptacle extending in the pulling-off direction, said receptacle receiving a model mold support, said model mold support in said receptacle being supported for displacement between the engagement position and the removal position along the pulling-off direction.

19. The device according to claim 18, wherein the model mold support is guided in a form-fitting manner in the receptacle of the separating platform, which has a sleeve-shaped base body.

20. The device according to claim 19, wherein the engagement hook of the puller comprises a hook base from which a hook end section extends substantially normally thereto, and said hook end section has at a free end thereof a contact surface configured to engage a hook engagement area on an underside of the model mold.
